(19) United States
(12) Patent Application Publication
(10) Pub. No.: US 2017/0193541 A1
(43) Pub. Date: Jul. 6, 2017

(54) AGRICULTURAL PRODUCTS PROCESSING CENTER ADAPTIVE ANALYSIS SYSTEM AND PROCESSING METHOD THEREOF

(71) Applicant: ELECTRONICS AND TELECOMMUNICATIONS RESEARCH INSTITUTE, Daejeon (KR)

(72) Inventors: Hyeon PARK, Daejeon (KR); Se Han KIM, Daejeon (KR); Eun Ju LEE, Daejeon (KR)

(21) Appl. No.: 15/361,737

(22) Filed: Nov. 28, 2016

(30) Foreign Application Priority Data
Dec. 30, 2015 (KR) 10-2015-0189388

(51) Int. Cl. G06Q 30/02; G06N 5/04

(52) U.S. Cl. CPC G06Q 30/0206; G06N 5/045; G06Q 30/0202

(57) ABSTRACT

An agricultural products processing center (APC) adaptive analysis processing system includes SaaS input/output system configured to implement agricultural product decision-making ERP system adapted to an APC by using an application program interface provided by SaaS platform, request analysis from PaaS analysis system, receive an analysis result, and output the analysis result to be visualized to only an APC which has requested the analysis, the PaaS analysis system configured to adaptively analyze demand and supply prediction and a demand and supply trend of agricultural products by using an analysis performing module in response to input data and the analysis request received from the ERP system, based on APC information and APC algorithms received from an IaaS storage system and transmit an analysis result to the SaaS input/output system, and the IaaS storage system configured to transmit the APC information and the APC algorithms to the PaaS analysis system.

### CROSS-REFERENCE TO RELATED APPLICATION(S)

This application claims priority under 35 U.S.C. §119 to Korean Patent Application No. 10-2015-0189388, filed Dec. 30, 2015, the disclosure of which is incorporated herein by reference in its entirety.

### BACKGROUND

1. Field of the Invention

The present invention relates to a cloud-based big data processing method and system which adaptively perform demand and supply prediction and price prediction on an agricultural products processing center (APC).

2. Description of Related Art

Recently, a system for analyzing and predicting the crop, purchase price, and the like of agricultural products is becoming increasingly interested, and a method of customizing and analyzing agricultural products by regional groups is being researched and developed.

An APC which is a regional government association is directly supplied with regional agricultural products (for example, onions, Chinese cabbages, etc.) from regional farmhouses and autonomously determines a purchase method and a purchase price. In this case, however, the purchase method and the purchase price are determined without accurate analysis, or an irrational purchase price is determined by using a uniform model instead of a model based on a purchase method suitable for a corresponding region. This is because regional APCs do not desire to disclose their own data (an output, price, etc.), and for this reason, a uniform analysis model is applied based on accumulated public data of all APCs.

Therefore, it is required to develop a model for analyzing and providing in real time an output prediction result for each of individual APCs without externally disclosing current information about each of the individual APCs.

Moreover, it is required to provide an independent model in which the unique purchase method of each of individual APCs is reflected.

### SUMMARY

Accordingly, the present invention provides a system and a method which, by implementing an enterprise resourcing planning (ERP) system adapted to each of individual APCs, predict demand and supply or analyze a demand and supply trend for each of APCs in consideration of the purchase method and/or the like of each APC, and disclose a corresponding analysis result to only a corresponding APC.

The present invention is for easily implementing an ERP system adapted to each of individual APCs, based on a software application program interface (API) provided by a software as a service (SaaS) input/output system.

The object of the present invention is not limited to the aforesaid, but other objects not described herein will be clearly understood by those skilled in the art from descriptions below.

In one general aspect, an agricultural products processing center (APC) adaptive analysis processing system 10 includes a software as a service (SaaS) input/output system 100 configured to implement an agricultural product decision-making enterprise resource planning (ERP) system 111 adapted to an individual APC by using an application program interface (API) provided by an SaaS platform, request analysis from a platform as a service (PaaS) analysis system 200, receive a result of the analysis, and output the analysis result to be visualized to only an individual APC which has requested the analysis, the PaaS analysis system 200 configured to adaptively analyze demand and supply prediction and a demand and supply trend of agricultural products by using an analysis performing module in response to input data and the analysis request received from the ERP system 111, based on APC information and APC algorithms received from an infrastructure as a service (IaaS) storage system 300 and transmit a result of the analysis to the SaaS input/output system 100, and the IaaS storage system 300 configured to transmit the APC information and the APC algorithm to the PaaS analysis system.

The SaaS input/output system 100 according to an embodiment of the present invention may further include the agricultural product decision-making ERP system 111 adapted to the individual APC, an analysis result output unit 114 that outputs an analysis result received from the PaaS analysis system 200 so as to be visualized to only an individual APC which has requested the analysis, and an API provider 121 that provides an API for implementing the agricultural product decision-making ERP system 111. Also, the SaaS input/output system may further include an analysis history reading unit that requests input information and an analysis result from the IaaS storage system to search for an analysis history.

An APC adaptive analysis storage system (200 and 300) according to an embodiment of the present invention may include an analysis request receiver 221 that receive input data and an analysis request from the SaaS input/output system 100, an input information determiner 222 that determines input information, based on the input data received from the SaaS input/output system, APC information and APC algorithms received from the IaaS storage system and issues a request to perform analysis, an analysis performing module 230 that adaptively analyzes each individual APC, an analysis result module 240 that transmits a result of the analysis to the SaaS input/output system 100, and a dynamic analysis providing module 320 that provides APC information and APC algorithms to the PaaS analysis system 200.

An APC adaptive analysis processing method according to an embodiment of the present invention may include inputting data to the ERP system adapted to an individual APC in step S410, transmitting the input data to the PaaS analysis system 200 to request analysis in step S420, determining input information based on the input data, APC information, and APC algorithms to issue a request to perform analysis in step S450, performing analysis adapted to the individual APC in step S460, transmitting a result of the analysis in step S470, and outputting the analysis result in step S480.

An APC adaptive input/output processing method according to an embodiment of the present invention may include providing, by a SaaS platform, APIs, extracting the APIs provided by the SaaS platform to generate a data input unit, an analysis request unit, and an analysis result output unit adapted to the individual APC, inputting input data through the data input unit in step S410, requesting, by the analysis request unit, analysis of the input data from the PaaS analysis system in step S420, and receiving, by the analysis result output unit, a result of the analysis to output the analysis result to be visualized to only the individual APC in step S480.

An APC adaptive analysis storing method according to an embodiment of the present invention may include receiving input data and an analysis request of an SaaS input/output system, determining input information, based on the input data of the SaaS input/output system, APC information and APC algorithms which are received from the SaaS input/output system in step S450, performing analysis adapted to an individual APC, based on the determined input information in step S460, and transmitting a result of the analysis to the SaaS input/output system in step S470.

Other features and aspects will be apparent from the following detailed description, the drawings, and the claims.

### BRIEF DESCRIPTION OF THE DRAWINGS

FIG. 1A and FIG. 1B are exemplary diagrams for describing a concept of an APC adaptive analysis processing system according to an embodiment of the present invention.

FIG. 2A and FIG. 2B are exemplary diagrams for describing a function of an APC adaptive analysis processing system according to an embodiment of the present invention.

FIG. 3A, FIG. 3B and FIG. 3C are block diagrams illustrating a detailed function of an APC adaptive analysis processing system according to an embodiment of the present invention.

FIG. 4A and FIG. 4B are flowcharts illustrating an APC adaptive analysis processing method according to an embodiment of the present invention.

FIG. 5 is a block diagram of edge-based load shedding system according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, embodiments of the present invention will be described in detail with reference to the accompanying drawings.

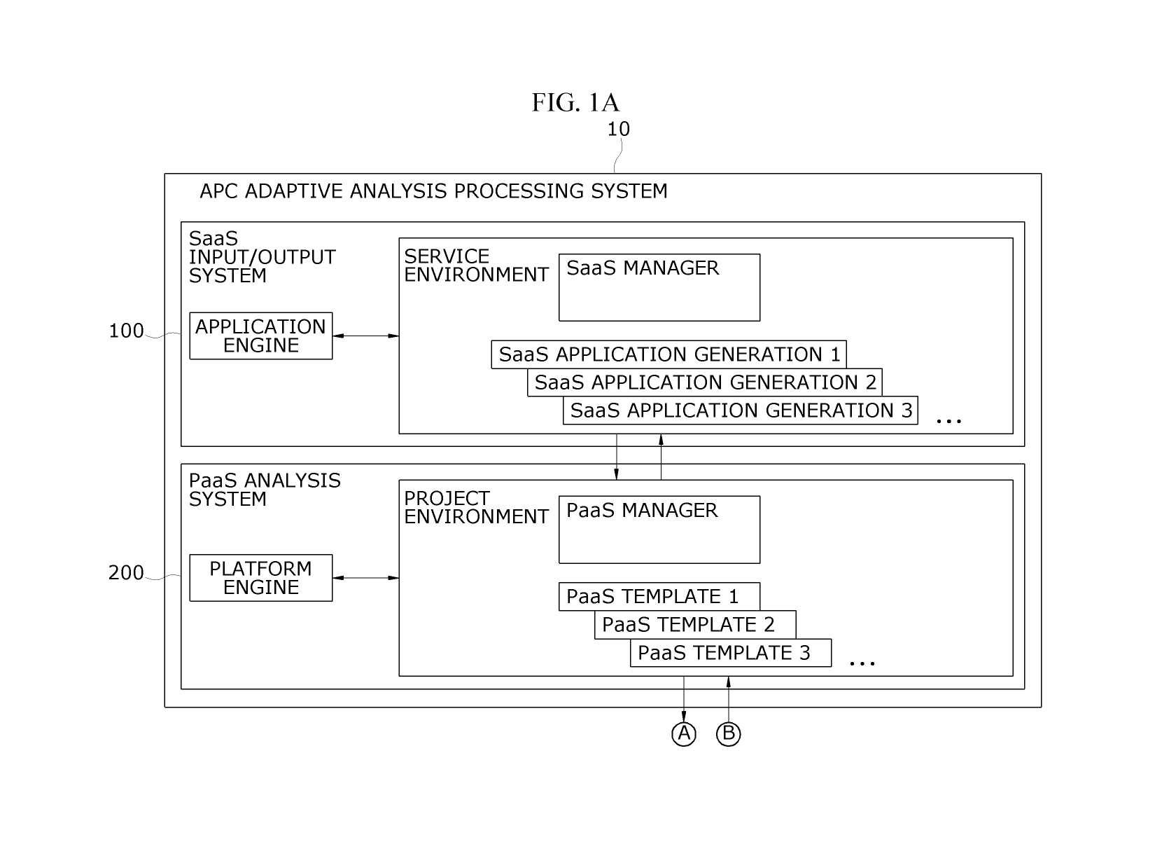

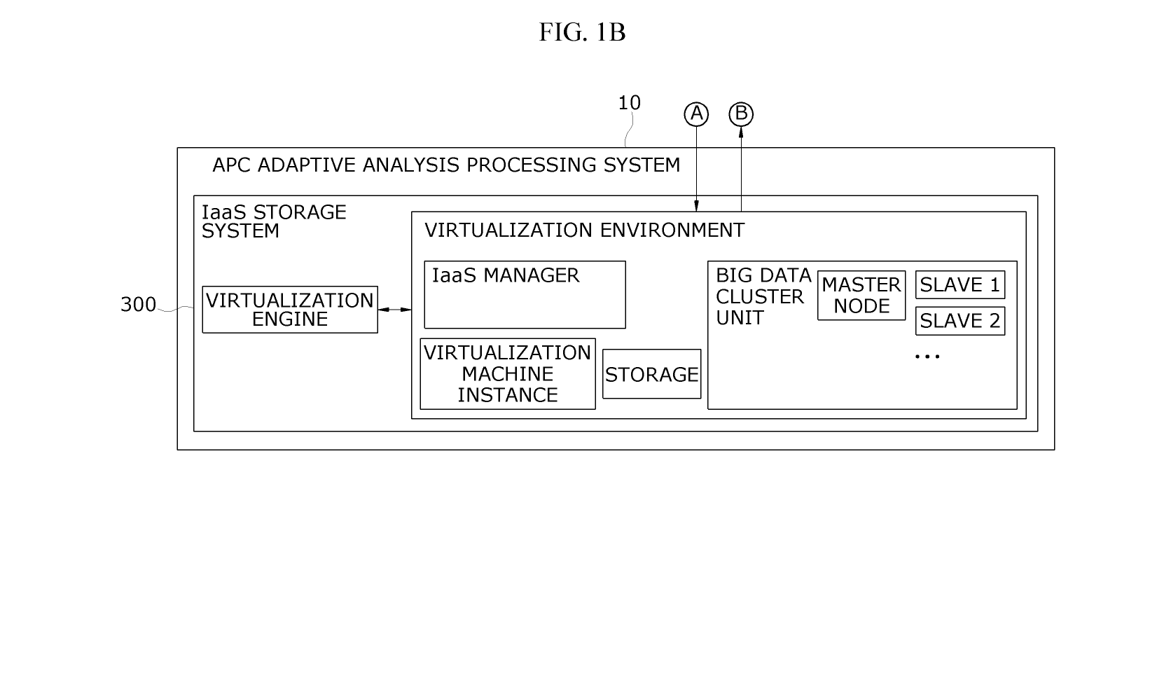

FIG. 1A and FIG. 1B are exemplary diagrams for describing a concept of an APC adaptive analysis processing system according to an embodiment of the present invention.

Cloud computing may be categorized into three fields such as software as a service (SaaS), platform as a service (PaaS), and infrastructure as a service (IaaS). The SaaS, as a service, denotes providing a software application service. The PaaS denotes a type for providing, as a service, a standardized platform instead of software. The IaaS denotes a type for providing, as a service, infrastructure such as a server, a storage, a network, etc.

The present invention provides an APC adaptive cloud-based big data analysis processing system and method in which an environment for implementing an SaaS application (an individual APC ERP system) is provided through an API provider of an SaaS platform, the implemented individual APC ERP system determines an analysis model according to input data autonomously input thereby to allow the analysis model to analyze information (an output, price, etc.) about each of individual APCs by using a dynamic adaptive analysis by a PaaS analysis system, and as a result of the analysis, an output prediction result of a corresponding individual APC is visualized in only the corresponding individual APC. Therefore, by providing an analysis model adapted to each of individual APCs instead of an analysis model identically applied to all conventional APCs, an accuracy of prediction is enhanced, and information about each of the individual APCs are prevented from being exposed to another APC.

In an SaaS input/output system 100, in order for analysis to be performed by using information (information such as a pas output, price, etc.) about an individual APC in a plurality of APCs, cloud-based information may be input, and an analysis result may be obtained.

The SaaS input/output system 100 may include a service environment, which enables application software to be easily developed by using an API, and an application engine for developing application software difficult to use the API.

A PaaS analysis system 200 may include a platform engine for developing a platform and a project environment module for developing a template of a development environment.

An IaaS storage system 300 may include a virtualization engine for developing virtualization of resources such as a server resource, a network, a storage, a process power, and the like for establishing infra, a module for managing virtualization, and a virtual big data cluster unit for processing actual big data.

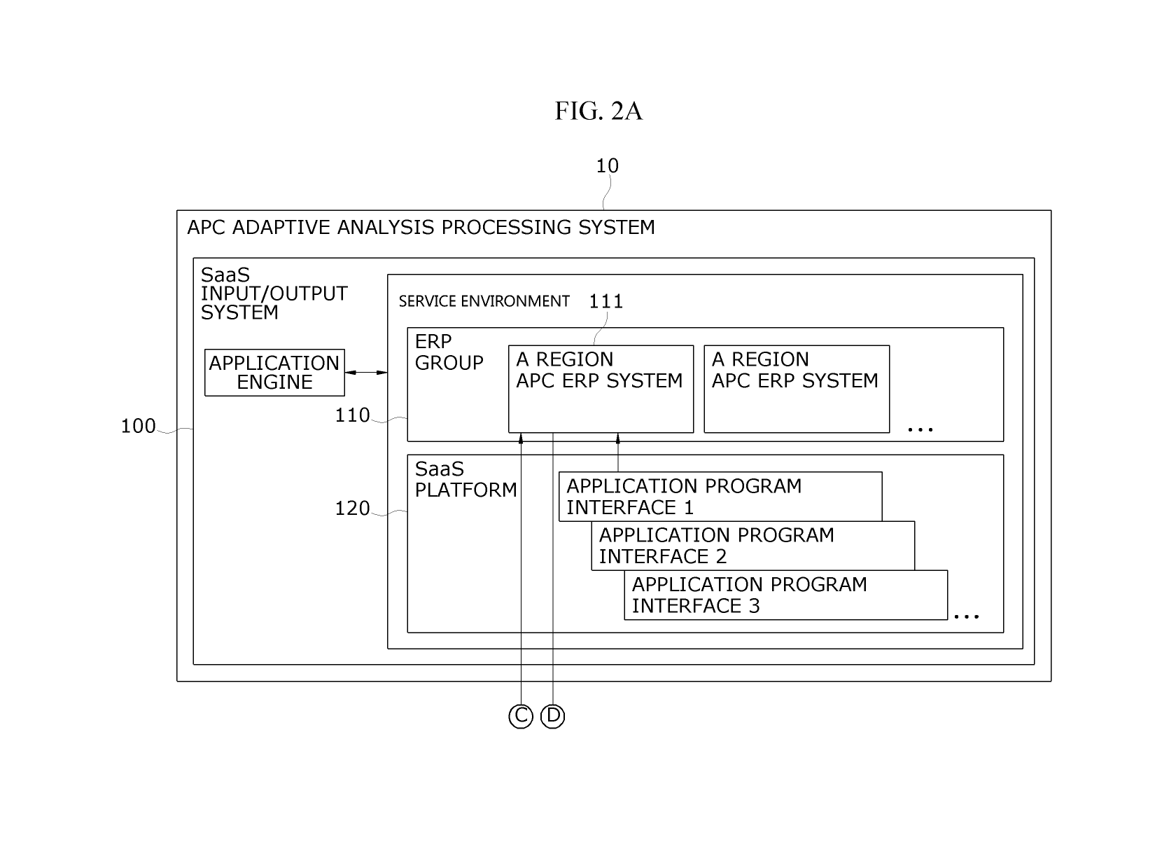

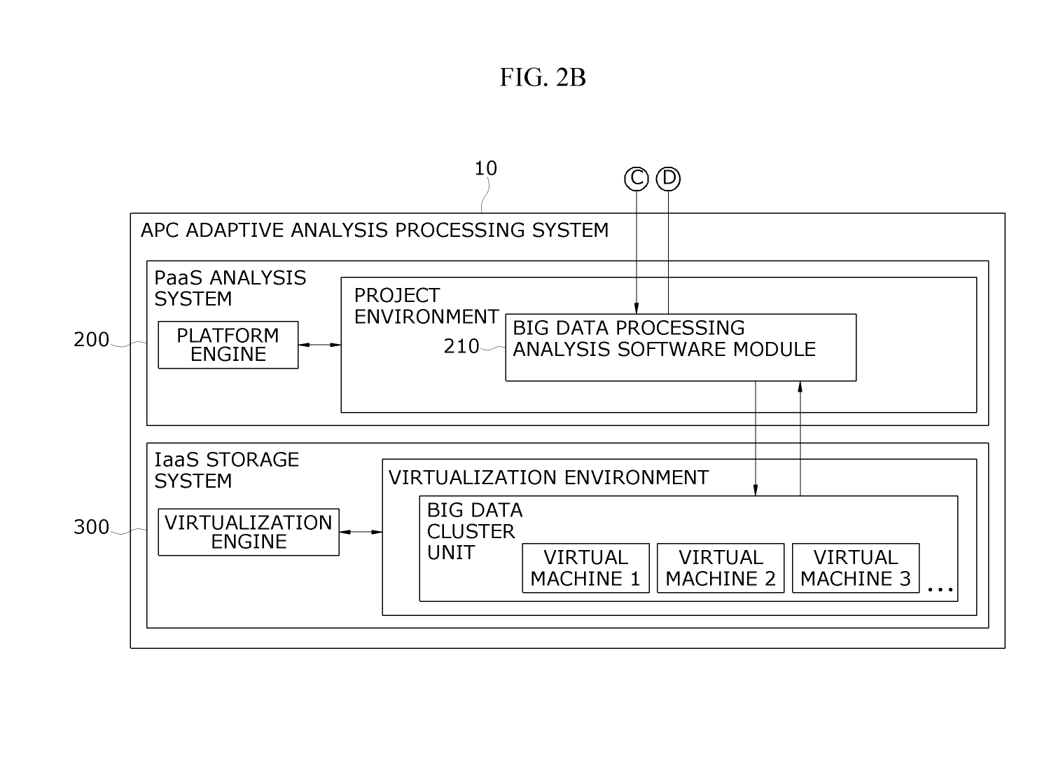

FIG. 2A and FIG. 2B are exemplary diagrams for describing a function of an APC adaptive analysis processing system according to an embodiment of the present invention.

The SaaS input/output system 100 may implement an agricultural product decision-making ERP system 111 adapted to an individual APC by using APIs provided by an SssS platform 120.

The PaaS analysis system 200 may provide a big data processing analysis software module 210 as a template of the project environment in order for big data to be analyzed by using input information about the individual APC.

The IaaS storage system 300 may include a big data cluster unit including one or more virtual machines which is(are) correspond to personal computers of one or more regional APCs in a one-to-one relationship.

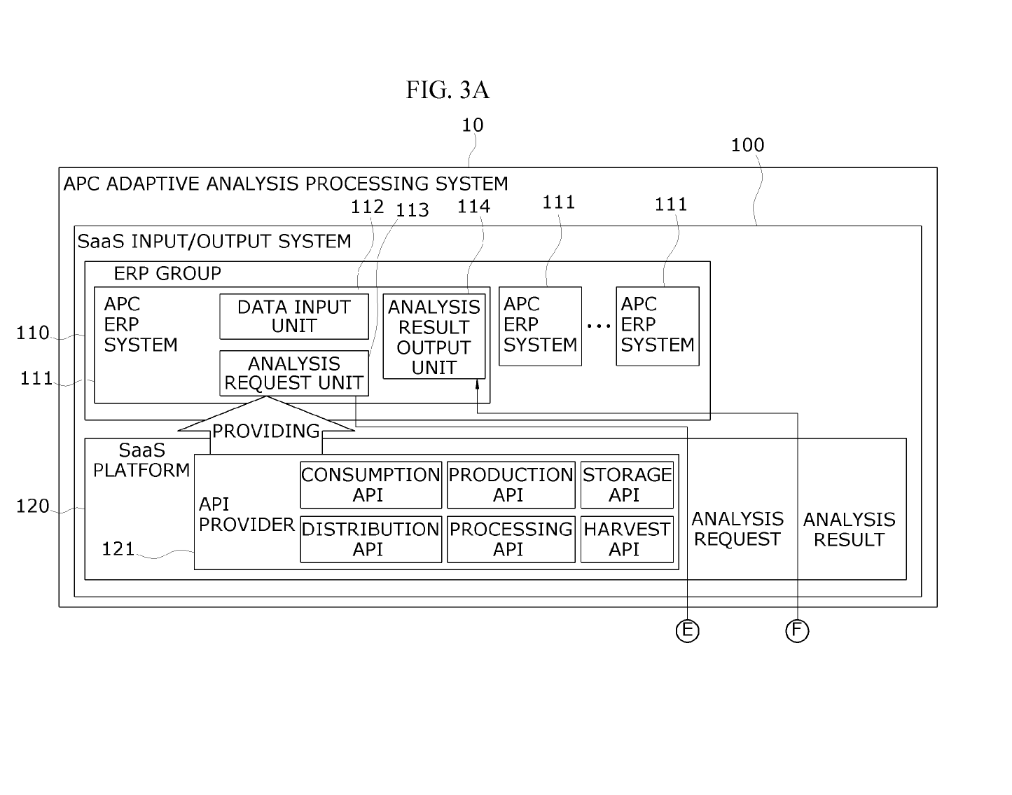

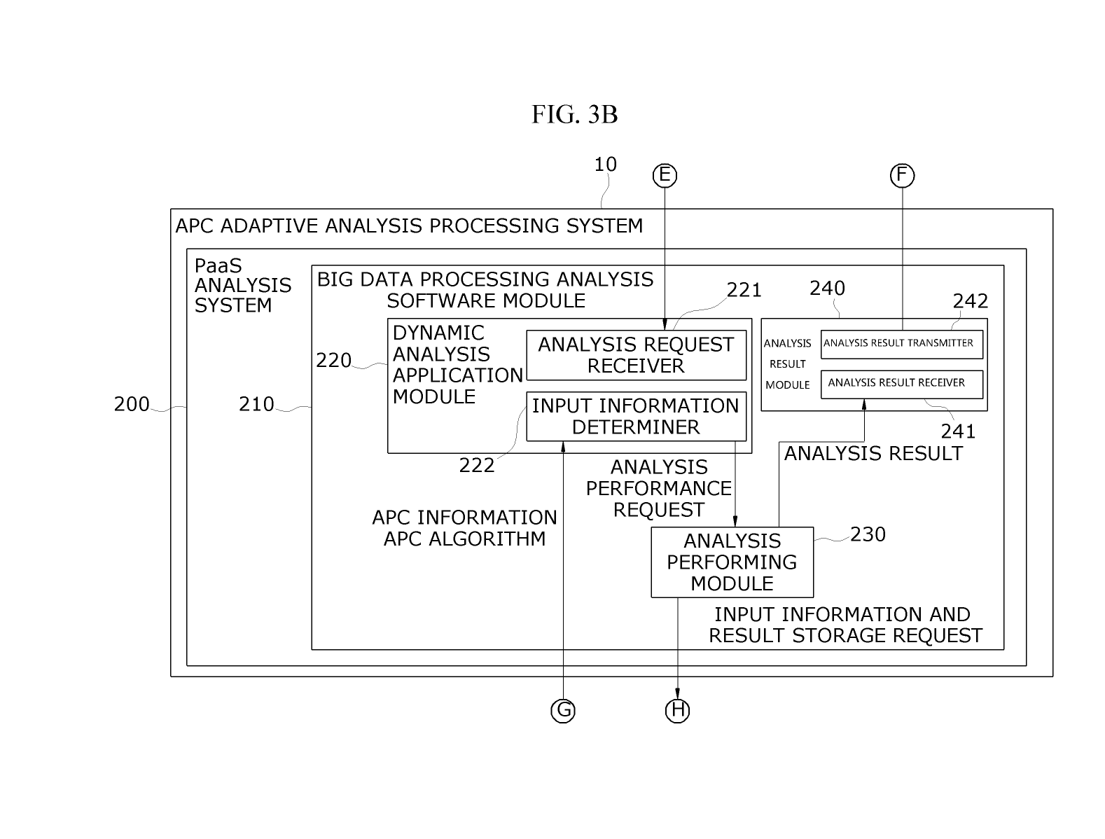

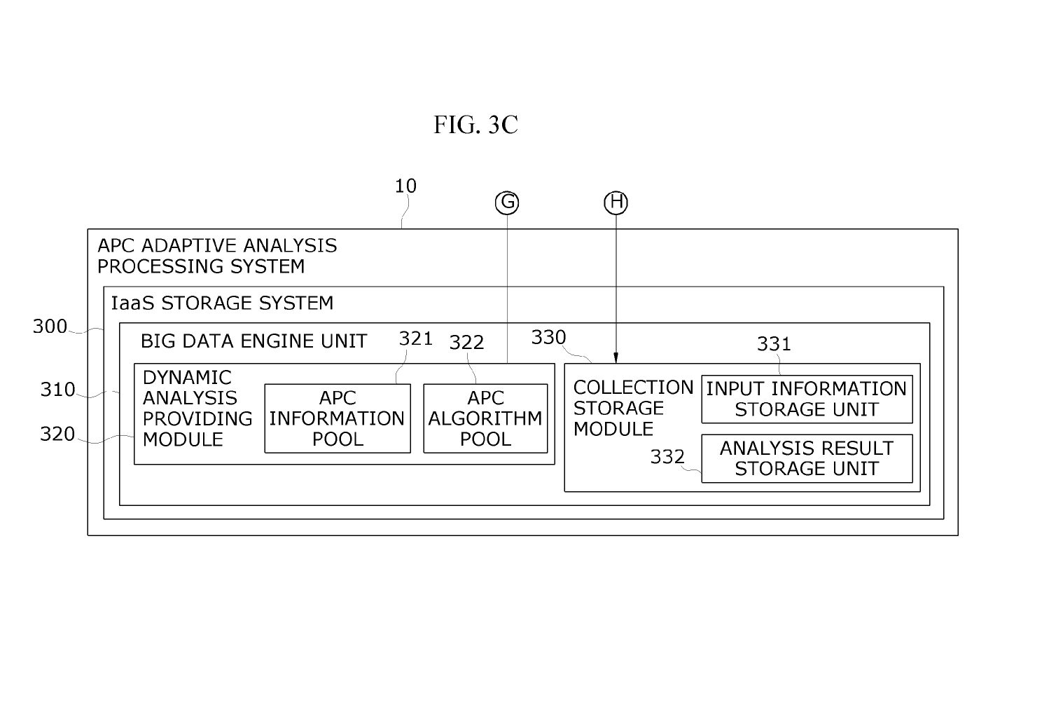

FIG. 3A, FIG. 3B and FIG. 3C are block diagrams illustrating a detailed function of an APC adaptive analysis processing system according to an embodiment of the present invention.

The APC adaptive analysis processing system according to an embodiment of the present invention may include the SaaS input/output system 100, the PaaS analysis system 200, and the IaaS storage system 300.

According to another embodiment, the APC adaptive analysis processing system according to an embodiment of the present invention may include the PaaS analysis system 200 and the IaaS storage system 300.

The SaaS input/output system 100 may implement the agricultural product decision-making ERP system 111 adapted to an individual APC by using the APIs provided by the SaaS platform 120. The SaaS input/output system 100 may request analysis from the PaaS analysis system 200, receive a result of the analysis, and output the analysis result so as to be visualized to only an individual APC which has requested the analysis.

The SaaS input/output system 100 may include an ERP group 110, configured with one or more agricultural product decision-making ERP systems 111, and an API provider 121 that provides APIs for implementing the agricultural product decision-making ERP system 111.

The ERP system 111 may be implemented with APIs provided by the API provider 121 of the SaaS platform 120. The ERP system 111 may extract only APIs necessary for an individual APC from among APIs implemented by the SaaS platform 120, and thus, the ERP system 111 adapted to the individual APC may be implemented.

The ERP system 111 may include a data input unit 112 that receives input data, an analysis request unit 113 that requests analysis from the PaaS analysis system 200, and an analysis result output unit 114 that outputs an analysis result received from the PaaS analysis system 200 so as to be visualized to only an individual APC which has requested the analysis.

The input data may include a regional APC identifier (ID), agricultural product items, agricultural product demand and supply data managed each of individual APCs, environment data of each of the individual APCs, and analysis request items.

The analysis request unit 113 may transmit the input data to the PaaS analysis system 200 and may request analysis. The analysis result output unit 114 of the ERP system 111 may output an analysis result of the agricultural product demand and supply prediction and demand and supply trend of each of individual APCs analyzed by the PaaS analysis system 200.

In this case, the SaaS input/output system 100 may further include an analysis history reading unit that requests input information and an analysis result from the IaaS storage system 300 to search for an analysis history.

In the PaaS analysis system 200, the big data processing analysis software module 210 may perform analysis, based on data input from the ERP system 111 of the SaaS input/output system 100, APC information, and APC algorithms and may transmit a result of the analysis to the SaaS input/output system 100.

The PaaS analysis system 200 may include a dynamic analysis application module 220, an analysis performing module 230, and an analysis result module 240.

The dynamic analysis application module 220 may include an analysis request receiver 221 and an input information determiner 222.

To provide a more detailed description, the analysis request receiver 221 may process input data received from the SaaS input/output system 100 with an interworking code and may transmit a result of the processing to the input information determiner 222.

The input information determiner 222 may determine input information, based on the interworking code, the APC information, and the APC algorithms received from the IaaS storage system 300.

The analysis performing module 230 may adaptively analyze each individual APC, based on the determined input information.

The analysis result module 240 may transmit a result of the analysis to the analysis result output unit 114 of the SaaS input/output system 100.

Moreover, the analysis performing module 230 may request input information and an analysis result from a collection storage module 330 of the IaaS storage system 300.

In the IaaS storage system 300, a dynamic analysis providing module 320 may provide the APC information pool 321 and the APC algorithm pool 322 which are to be used by the dynamic analysis application module 220.

The APC information pool 321 may include past data such as an output, a purchase amount, a purchase price, a purchase time, etc. The APC algorithm pool 322 may be an ID list of one or more analysis models adapted to each of individual APCs, and each of algorithms included in the APC algorithm pool 322 may be implemented in the analysis performing module 230. An analysis target to which the an analysis module is to be applied may be one of demand and supply prediction, a demand and supply trend, unit output prediction, cultivation area prediction, and a wholesale price.

The IaaS storage system 300 may include the dynamic analysis providing module 320 and the collection storage module 330.

Here, the dynamic analysis providing module 320 may provide the APC information pool 321 and the APC algorithm pool 322 to the dynamic analysis application module 220 of the PaaS analysis system 200 to enable analysis adapted to each of individual APCs.

The collection storage module 330 may receive, collect, and store input information and an analysis result storage request from the analysis performing module 230 of the PaaS analysis system 200. Also, the collection storage module 330 may provide an analysis history including input information, an analysis result, etc. according to an analysis history reading request of the SaaS input/output system 100. Also, the collection storage module 300 may store the input information and the analysis result according to a storage request of the analysis performing module 230.

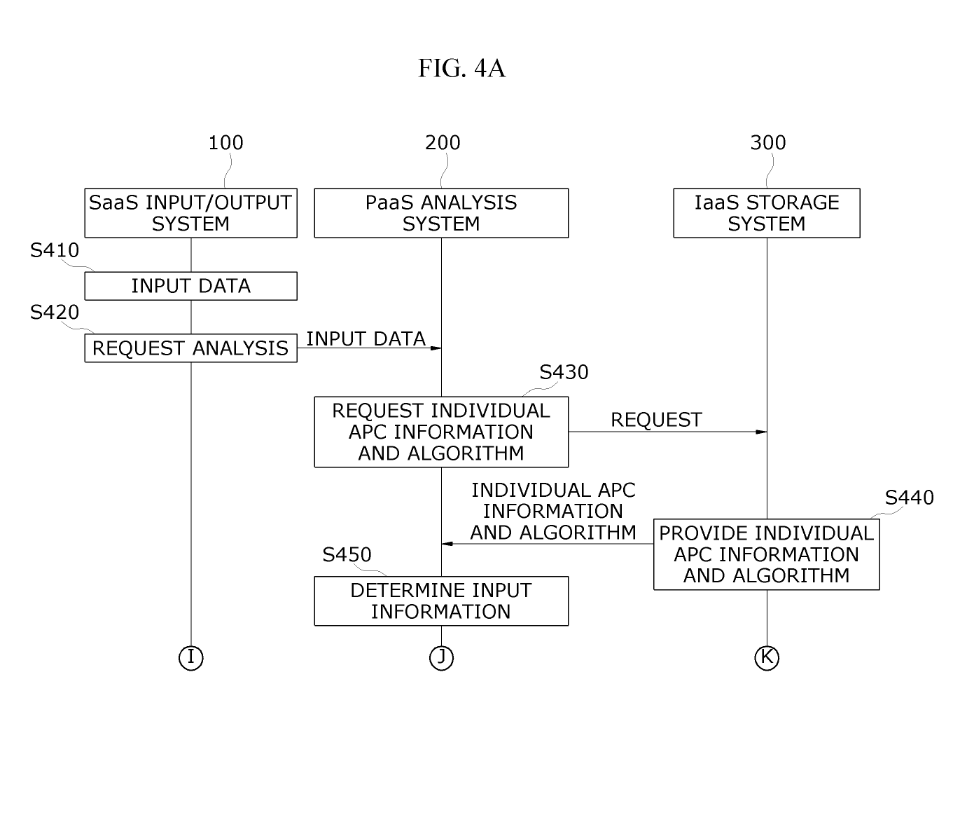

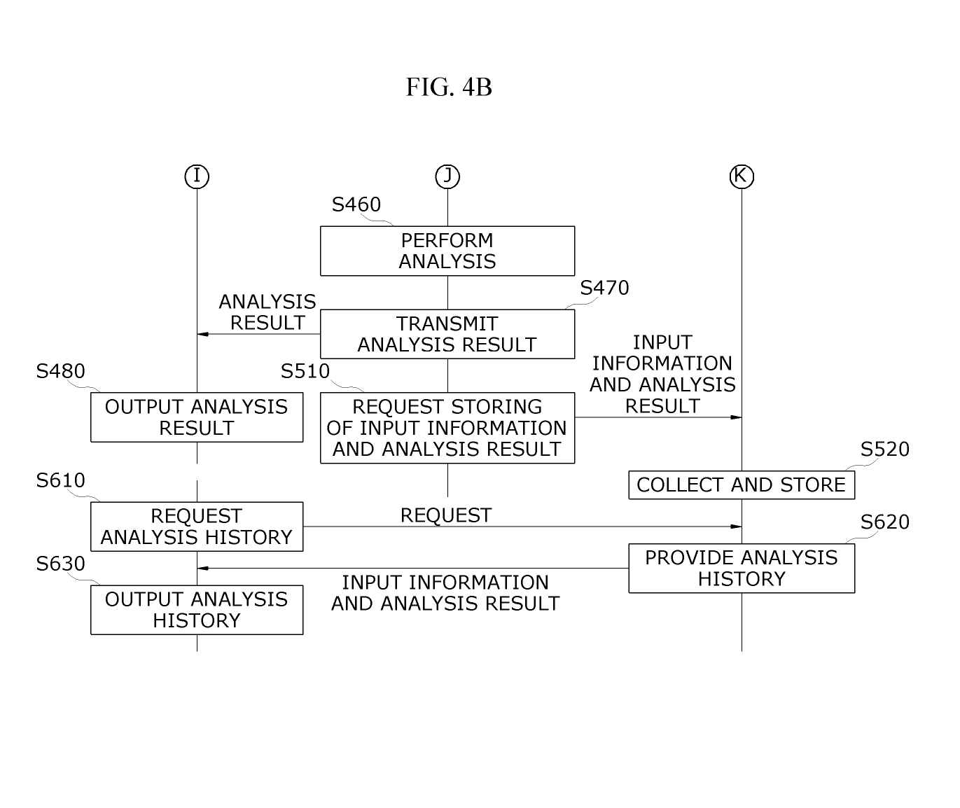

FIG. 4A and FIG. 4B are flowcharts illustrating an APC adaptive analysis processing method according to an embodiment of the present invention.

The APC adaptive analysis processing method may include an APC adaptive input/output processing method and an APC adaptive analysis storage processing method.

The APC adaptive analysis processing method according to an embodiment of the present invention may input data to the ERP system 111 adapted to an individual APC in step S410, transmit the input data to the PaaS analysis system 200 to request analysis in step S420, determine input information based on the input data, APC information, and an APC algorithms to issue a request to perform analysis in step S450, perform analysis adapted to the individual APC in step S460, transmit a result of the analysis in step S470, and receive, by the analysis result output unit 114, the analysis result and output the analysis result to be visualized to only the individual APC in step S480.

In this case, the APC adaptive analysis processing method may additionally issue a request to store the input information and the analysis result in step S510 and store the input information and the analysis result in step S520.

In this case, the SaaS input/output system 100 may issue a request, to the IaaS storage system 300, to request an analysis history in step S610, receive the analysis history from the IaaS storage system 300 in step S620, and output the analysis history provided from the IaaS storage system 300.

The APC adaptive analysis processing method according to an embodiment of the present invention may provide, by the SaaS platform, APIs, extract the APIs provided by the SaaS platform to generate the data input unit 112, the analysis request unit 113, and the analysis result output unit 114 adapted to the individual APC, input the input data through the data input unit 112 in step S410, request, by the analysis request unit 113, an analysis of the input data from the PaaS analysis system in step S420, and receive, by the analysis result output unit 114, a result of the analysis and output the analysis result to be visualized to only the individual APC in step S480.

In this case, the APIs may include one of a production API, a harvest API, a storage API, a distribution API, a processing API, and a consumption API.

In this case, the SaaS input/output system 100 may issue a request, to the IaaS storage system 300, to request an analysis history in step S610 and may output the analysis history provided from the IaaS storage system 300 in step S300.

The APC adaptive analysis processing method according to an embodiment of the present invention may receive input data and an analysis request from the SaaS input/output system 100, determine input information based on the input data from the SaaS input/output system 100 and the APC information and the APC algorithm which are received from the IaaS storage system 300 in step S450, perform analysis adapted to the individual APC based on the determined input information in step S460, and transmit a result of the analysis to the SaaS input/output system 100 in step S470.

In this case, the APC adaptive analysis processing method may additionally issue a request to store the input information and the analysis result in step S510 and store the input information and the analysis result in step S520.

Moreover, the APC adaptive analysis processing method may additionally provide the analysis history in response to the analysis history request (S610) of the SaaS input/output system 100 in step S620.

According to the embodiments of the present invention, the individual APC ERP system is easily implemented, and by dynamically performing analysis suitable for a corresponding APC by using SaaS input information, demand and supply prediction and an analysis of an agricultural products trend appropriate for a corresponding APC may be performed. Accordingly, decision-making of agricultural products are easily and accurately performed, and information about each of individual APCs may be analyzed without being exposed to the outside, thereby increasing benefits of all of farmers and APCs.

Moreover, according to the embodiments of the present invention, an analysis prediction service (demand and supply prediction, unit output prediction, cultivation area prediction, wholesale price prediction, etc.) may be provided by applying different purchase methods to individual APCs and may be used as a planning production decision-making tool (development of decision-making support technology for determining purchase, storage, and release times by a marketer and an manager of a regional processing center).

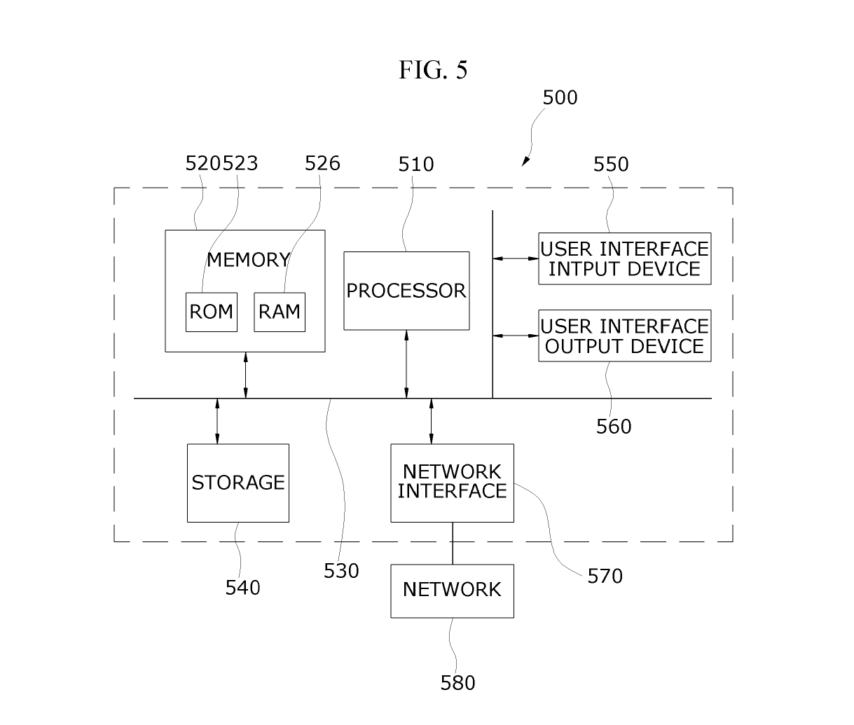

FIG. 5 is a block diagram of edge-based load shedding system according to an embodiment of the present invention.

An embodiment of the present invention may be implemented in a computer system, e.g., as a computer readable medium. As shown in FIG. 5, a computer system 500 may include one or more of a processor 510, a memory 520, a user input device 550, a user output device 560, and a storage 540, each of which communicates through a bus 530. The computer system 500 may also include a network interface 570 that is coupled to a network 580. The processor 510 may be a central processing unit (CPU) or a semiconductor device that executes processing instructions stored in the memory 520 and/or the storage 540. The memory 520 and the storage 540 may include various forms of volatile or non-volatile storage media. For example, the memory may include a read-only memory (ROM) 523 and a random access memory (RAM) 526.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An agricultural products processing center (APC) adaptive analysis processing system comprising:
a software as a service (SaaS) input/output system configured to implement an agricultural product decision-making enterprise resource planning (ERP) system adapted to an individual APC by using an application program interface (API) provided by an SaaS platform, request analysis to a platform as a service (PaaS) analysis system, receive a result of the analysis from the PaaS system, and output the analysis result to be visualized to only an individual APC which has requested the analysis;
a PaaS analysis system configured to adaptively analyze demand and supply prediction and a demand and supply trend of agricultural products by using an analysis performing module in response to input data and the analysis request received from the ERP system, based on APC information and APC algorithms of an infrastructure as a service (IaaS) storage system and transmit a result of the analysis to the SaaS input/output system; and
an IaaS storage system configured to transmit the APC information and the APC algorithms to the PaaS analysis system.

2. The APC adaptive analysis processing system of claim 1, wherein the input data comprises at least one of a regional APC identifier (ID), agricultural product items, agricultural product demand and supply data, environment data of the individual APC, and analysis request items.

3. The APC adaptive analysis processing system of claim 1, wherein the APC information is past data corresponding to the individual APC and comprises at least one of a purchase amount, a purchase price, and an output.

4. The APC adaptive analysis processing system of claim 1, wherein the APC algorithms comprises at least one of a demand and supply prediction algorithms, demand and supply trend algorithms, unit output prediction algorithms, cultivation area prediction algorithms, and wholesale price prediction algorithms, based on an analysis target.

5. The APC adaptive analysis processing system of claim 1, wherein:
the analysis performing module issues a request to store the input information and the analysis result, and
the IaaS storage system comprises a collection storage module configured to collect and store the input information and the analysis result in response to a storage request for storing the input information and the analysis result from the analysis performing module.

6. The APC adaptive analysis processing system of claim 1, wherein the IaaS storage system comprises:
a dynamic analysis providing module configured to store the APC information and the APC algorithms and transmit the APC information and the APC algorithms to the PaaS analysis system; and
a collection storage module configured to collect and store input information about each of individual APCs and analysis results from the PaaS analysis system.

7. The APC adaptive analysis processing system of claim 1, wherein the ERP system comprises:
an data input unit configured to receive a regional APC identifier (ID), agricultural product items, agricultural product demand and supply data, environment data of each of individual APCs, and analysis request items;
an analysis request unit configured to request analysis from the PaaS analysis system; and
an analysis result output unit configured to output a result of the analysis, received from the PaaS analysis system, to be visualized to only an APC which has requested the analysis.

8. An agricultural products processing center (APC) adaptive analysis processing method comprising:
inputting input data in an agricultural product decision-making enterprise resource planning (ERP) system;
transmitting the input data to a platform as a service (PaaS) analysis system to request analysis;
determining input information based on the input data, APC information, and an APC algorithms to apply a dynamic analysis;
perform analysis on demand and supply prediction and a demand and supply trend of agricultural products adapted to an individual APC by using the applied dynamic analysis;
transmitting, by the PaaS analysis system, a result of the analysis to the SaaS input/output system; and
outputting, by the ERP system, the analysis result to be visualized to only the individual APC.

9. The APC adaptive analysis processing method of claim 8, wherein the input data comprises a regional APC identifier (ID), agricultural product items, agricultural product demand and supply data, environment data of the individual APC, and analysis request items.

10. The APC adaptive analysis processing method of claim 8, wherein the APC information is past data corresponding to the individual APC and comprises a purchase amount, a purchase price, and an output.

11. The APC adaptive analysis processing method of claim 8, wherein the APC algorithms comprises demand and supply prediction algorithms, demand and supply trend algorithms, unit output prediction algorithms, cultivation area prediction algorithms, and wholesale price prediction algorithms, based on an analysis target.

12. The APC adaptive analysis processing method of claim 8, wherein the performing of the analysis comprises:
collecting the input information and the analysis result; and
storing the input information and the analysis result.

13. The APC adaptive analysis processing method of claim 12, further comprising: searching for an analysis history from the stored input information and analysis result.

14. An agricultural products processing center (APC) adaptive input/output processing method comprising:
providing, by a software as a service (SaaS) platform, application program interfaces (APIs) to an enterprise resource planning (ERP) system adapted to an individual APC;
extracting, by the ERP system, the APIs provided by the SaaS platform to generate a data input unit, an analysis request unit, and an analysis result output unit adapted to the individual APC;
inputting input data through the data input unit;
requesting, by the analysis request unit, analysis from the PaaS analysis system by using the input data;
generating, by the PaaS analysis system, a dynamic analysis application model to determine input information by using the input data, APC information, and an APC algorithms, and performing analysis on demand and supply prediction and a demand and supply trend of agricultural products adapted to an individual APC; and
outputting, by the analysis result output unit, a result of the analysis received from the PaaS analysis system to be visualized to only the individual APC.

15. The APC adaptive input/output processing method of claim 14, wherein the APIs comprise at least one of a production API, a harvest API, a storage API, a distribution API, a processing API, and a consumption API.
